(19) United States
(12) Patent Application Publication
(10) Pub. No.: US 2001/0034599 A1
(43) Pub. Date: Oct. 25, 2001

(54) Method for providing translation service

(75) Inventors: Kouzou Kage, Tokyo (JP); Hiromitsu Suzuki, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/825,792

(22) Filed: Apr. 4, 2001

(30) Foreign Application Priority Data
Apr. 7, 2000 (JP) 2000-106095

(51) Int. Cl. G06F 17/28

(52) U.S. Cl. 704/3; 704/2

(57) ABSTRACT

A method for providing translation service through a network, comprises the steps of (Step 1) delivering language information as to its own language as well as the other person's language, a telephone number of a first cellular phone 1 as well as a telephone number of a second cellular phone 2 belonging to the other person together with information for requesting translation from the first cellular phone 1 to a network 3 at the time of establishing a phone line; (Step 2) connecting the first cellular phone 1 with the second cellular phone 2 by means of the network 3 through a translating apparatus 6 which has been previously prepared; (Step 3) translating a speaking in the first cellular phone 1 and a speaking in the second cellular phone 2 by means of the translating apparatus 6 in accordance with the language information to deliver both the spoken contents translated to their opposite parties' cellular phones 2 and 1, respectively; and (Step 4) counting a time required for the translation by means of an accounting apparatus 7, which has been prepared previously on the network 3, to charge the fee as a translation fee, and adding the translation fee to a rate for a call caused by a phone call between the first cellular phone 1 and the second cellular phone 2, whereby communication between persons who speak different languages becomes easy irrespective of a place where they are now present and a time required for accessing to such translation means.

### FIELD OF THE INVENTION

The present invention relates to a method for providing translation service, and more particularly to a method for providing translation service by which it becomes possible to understand with each other between users who are different in their native languages in a mobile communication system such as cellular phones irrespective of a place where they are now present and a time required for accessing to such translation means.

### BACKGROUND OF THE INVENTION

Heretofore, translation service has been provided in such a manner that user's speaking has been previously recorded in a translation machine, and the speaking is analyzed and translated by the machine. In case of such processing, however, the translation is implemented in a place where the translation machine is installed.

Furthermore, concerning a system wherein translation service is applied to phone call in a telephone system, there have been proposed, for example, a method for mounting a translating means on a satellite in a cellular phone system wherein communication is performed by the use of an international cellular phone satellite (Japanese Patent Kokai No. 11-112665), a method for connecting directly a hand-held translation device to a cellular phone (Japanese Patent Kokai 11-110399), and a method for mounting a translating means to a telephone booth (Japanese Patent Kokai No. 10-336354).

In a conventional method for providing translation service as mentioned above, when a user wishes to employ a translation system, the user must go to a place where a target translation machine is installed, or the user must send the contents of his (or her) conversation to a translation machine, and then the translated contents must be received from the translation machine, because such translation machine is a massive production. Thus, there are restrictions due to a place where such translation machine resides or a user who wishes to utilize the translation machine is now present, besides a time required for accessing to the translation machine, so that a conventional translation system is poor in usability in real time.

Moreover, in the method for connecting directly a hand-held translation device to a cellular phone, it is inconvenient to carry on the translation device, besides there is such a disadvantage that the translation device itself is expensive.

There have been such problems in a method for mounting a translating means to a telephone booth that a user must go to a place where a dedicated telephone booth provided with the translating means exists, and that such method is not appropriate in the case where someone wishes to talk with another who stands in front of his (or her) eyes and speaks a different language with the use of such translating device.

Furthermore, with respect to a method for mounting a translating means on a satellite in a cellular phone system wherein communication is performed by the use of an international cellular phone satellite, there have been the following disadvantages, i.e., (1) the method is unsuitable for translating different languages that are used by persons who communicate with each other in their sights with the use of their own cellular phones in a certain country. In addition, (2) a grand production is required in the case where a means for translation is operated for high speed processing, and high-capacity processing is performed in response to a large number of users's request who use plural types of languages in the world, so that such grand production is unsuitable for setting off in the form of a satellite, and (3) the method is inexpedience in view of both maintenance and economy of language data base.

### SUMMARY OF THE INVENTION

Accordingly an object of the present invention is to eliminate disadvantages involved in the prior art, and to provide high-capacity translation service in real time processing irrespective of places. Particularly the invention contemplates to provide such service by which the contents of conversation can understand on the moment in even the case where persons who speak different languages in their sights with respect to a number of users.

In order to achieve the above described objects, according to a first invention of the present application, a method for providing translation service through a network, comprises the steps of:

(Step 1) delivering language information as to its own language as well as the other person's language, a telephone number of a first telephone terminal as well as a telephone number of a second telephone terminal belonging to the other person together with information for requesting translation from the first telephone terminal to the network at the time of establishing a phone line,

(Step 2) connecting the first telephone terminal with the second telephone terminal by means of the network through a translating apparatus, which has been previously prepared;

(Step 3) translating a speaking in the first telephone terminal and a speaking in the second telephone terminal by means of the translating apparatus in accordance with the language information to deliver both the spoken contents translated to their opposite parties' telephone terminals respectively; and

(Step 4) counting a time required for the translation by means of an accounting apparatus which has been prepared on the network, to charge the fee as a translation fee, and adding the translation fee to a rate for a call caused by a phone call between the first telephone terminal and the second telephone terminal.

According to a second invention of the application, a method for providing translation service is characterized by that the first telephone terminal and the second telephone terminal of the first invention are cellular phones or Personal Handy Phones, respectively.

According to a third invention of the application, a method for providing translation service is characterized by that the network of the first invention is a fixed telephone network.

According to a fourth invention of the application, a method for providing translation service is characterized by that the network of the first invention is an Internet telephone network.

According to a fifth invention of the application, a method for providing translation service through a network comprises the steps of:

(Step 1) delivering language information as to languages spoken by a first telephone terminal and a second telephone terminal together with information for requesting translation from either of the first telephone terminal and the second telephone terminal to the net work in the case where a phone line for a phone call is in an established condition between the first telephone terminal and the second telephone terminal;

(Step 2) reconnecting the first telephone terminal with the second telephone terminal by means of the network through a translating apparatus which has been previously prepared;

(Step 3) translating a speaking in the first telephone terminal and a speaking in the second telephone terminal by means of the translating apparatus in accordance with the language information to deliver both the spoken contents translated to their opposite parties' telephone terminals, respectively; and

(Step 4) counting not only a rate for a call produced by a phone call between the first telephone terminal and the second telephone terminal, but also separately a charging usage of the translating apparatus by means of an accounting apparatus, which has been prepared previously on the network with respect to the first telephone terminal or the second telephone terminal from either of which the translation was requested.

According to a sixth invention of the application, a method for providing translation service is characterized by that the first telephone terminal and the second telephone terminal of the fifth invention are cellular phones or Personal Handy Phones, respectively.

According to a seventh invention of the application, a method for providing translation service is characterized by that the network of the fifth invention is a fixed telephone network.

According to an eighth invention of the application, a method for providing translation service is characterized by the network of the fifth invention is an Internet telephone network.

### BRIEF DESCRIPTION OF THE DRAWINGS

The present invention will be explained in more detail in conjunction with appended drawings, wherein:

FIG. 1 is a constitutional view illustrating a first preferred embodiment of a translation system to which a method for providing translation service according to the present invention is to be applied; and

FIG. 2 is a constitutional view illustrating a second preferred embodiment of a translation system to which a method for providing translation service according to the present invention is to be applied.

### DESCRIPTION OF THE PREFERRED EMBODIMENTS

Preferred embodiments of the invention will be described in detail hereinafter by referring to the accompanying drawings.

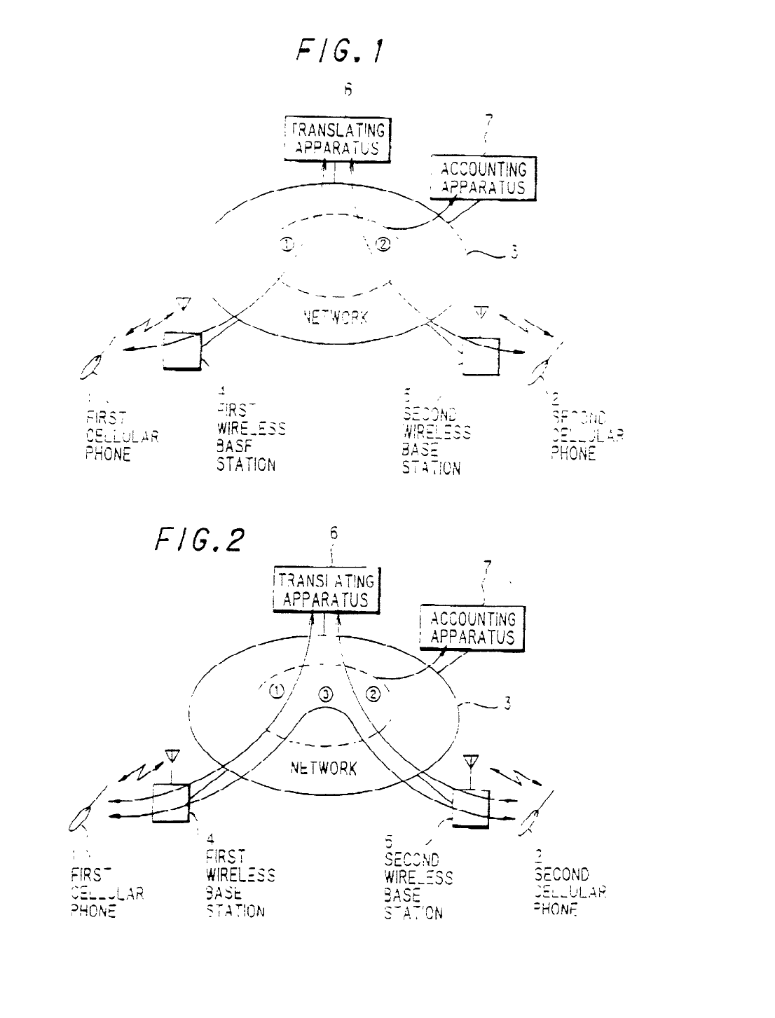

FIG. 1 is a constitutional view illustrating a first preferred embodiment of a translation system to which a method for providing translation service according to the present invention is to be applied.

Referring to FIG. 1, when an initial line of contact is established between a first cellular phone 1 and a second cellular phone 2, such connection of a phone line is made through a translating apparatus 6.

In this case, the first cellular phone 1 (or the second cellular phone 2) delivers language information as to its own language and the other person's language, its own telephone number and information for requesting translation to a network 3 at the time of connection for the phone line.

A phone line (1) extending from the first cellular phone 1 to the translating apparatus 6 is composed of a first wireless base station 4 for connecting wirelessly the first cellular phone 1 with the network 3, and the network 3 extending from the first wireless base station 4 to the translating apparatus 6 for the connection between them. On one hand, a phone line (2) extending from the translating apparatus 6 to the second cellular phone 2 is composed of the network 3 for extending from the translating apparatus 6 to a second wireless base station 5 for the connection between them, and the second wireless base station 5 for connecting wirelessly the second cellular phone 2 with the network 3.

Furthermore, a rate for a call of the phone call between the first cellular phone 1 and the second cellular phone 2 is charged in an accounting apparatus 7 wherein a charging usage of the translating apparatus 6 caused by a cellular phone terminal by which translation was requested is also charged with the accounting apparatus 7 to be added to determine a total charge.

Operations of the first preferred embodiment according to the present invention will be described hereinafter in the form of flow.

(Step 1) The first cellular phone 1 (or the second cellular phone 2) delivers language information as to its own language and the other person's language, its own telephone number being assigned to its own cellular phone terminal as well as the other person's telephone number and information for requesting translation to a network 3 at the time of connection in the phone line

(Step 2) The network 3 connects the first cellular phone with the second cellular phone 2 through the translating apparatus 6.

(Step 3) The translating apparatus 6 translates a speaking to the first cellular phone 1 as well as a speaking in the second cellular phone 3 in accordance with the above-described language information, and then, delivers both the spoken contents translated to their opposite parties, i.e., the second and first cellular phones 2 and 1, respectively.

(Step 4) The accounting apparatus 7 counts a period of time required for translation and charges the fee as translation charge to a user corresponding to the telephone number contained in the own station, and the resulting translation charge is added to the rate for call produced in a phone call between the first and second cellular phones 1 and 2.

In the above-mentioned step 1, translation requesting information is generally a special service code, in this case two methods may be considered, i.e., one of which is such that a user has previously stored language information as to his (or her) own language as well as the other person's language, his own telephone number, and the other person's telephone number together with the special service code, and these contents are delivered all at once to a network, and the other of which is a method wherein the information is delivered interactively to the network.

In the above-mentioned step 2, the network 3 has connected the first cellular phone 1 with the second cellular phone 2 through the translating apparatus 6 and an example of a means for fulfilling such connection, a general connection for three party service may be considered.

In case of three party service when a phone call is made from the first cellular phone 1 to the network 3 through equipment of the first wireless base station 4, the network 3 connects the phone line (1) and at the same time, notifies of the language information and the own telephone number as well as the other person's telephone number to the translating apparatus 6, and then the following phone call is made with respect to the second cellular phone 2 through the second base station 5 while maintaining connection of the phone line (1), whereby connection of the phone line (2) is established.

FIG. 2 is a constitutional view illustrating a second preferred embodiment of a translation system to which a method for providing translation service according to the present invention is to be applied.

The second preferred embodiment illustrates a situation wherein either of first and second cellular phones 1 and 2 has been made directly a phone call with respect the other person. More specifically, in a first step, a first cellular phone 1 is connected with a second cellular phone 2 by means of a phone line (3) in a network 3 through a first wireless base station 4 and a second wireless base station 5.

In a second step, when either of the first and second cellular phones 1 and 2 delivers language information as to its own language as well as the other person's language together with information for requesting translation to the network 3 for the sake of translating the own and the other person's languages in process of conversation, a phone line (1) for the first cellular phone 1 is connected with a phone line (2) for the second cellular phone 2 through a translating apparatus 6, respectively.

Namely, the phone line (1) extending from the first cellular phone 1 to the translating apparatus 6 is composed of the first wireless base station 4 for connecting wirelessly the first cellular phone 1 with the network 3, and the network 3 extending from the first wireless base station 1 to the translating apparatus 6 for the connection between them. On one hand, the phone line (2) extending from the translating apparatus 6 to the second cellular phone 2 is composed of the network 3 extending from the translating apparatus 6 to the second wireless base station 5 for the connection between them, and the second wireless base station 5 for connecting wirelessly the second cellular phone 2 with the network 3.

Furthermore, a rate for a call of the phone call between the first cellular phone 1 and the second cellular phone 2 is charged in an accounting apparatus 7 wherein the accounting apparatus 7 counts not only the rate for call due to connection of a phone line between the first cellular phone terminal 1 and the second cellular phone terminal 2, but also separately a charging usage of the translating apparatus 6 as translation fee with respect to either of the first cellular phone terminal 1 and the second cellular phone terminal 2 by which translation was requested.

Operations of the second preferred embodiment according to the present invention will be described hereinafter in the form of flow.

(Step 1) In the case where a phone line is in an established condition for a phone call between the first cellular phone 1 and the second cellular phone 2 as a result of connection of the phone line (3) in the network 3, either of the first and second cellular phones 1 and 2 delivers language information as to its own language and the other person's language together with information for requesting translation to the network 3.

(Step 2) The network 3 reconnects the first cellular phone 1 with the second cellular phone 2 through the translation apparatus 6.

(Step 3) The translating apparatus 6 translates a speaking in the first cellular phone 1 and a speaking in the second cellular phone 2 in accordance with the above-described language information, respectively, and then delivers both the spoken contents thus translated to their opposite parties, i.e., the second and the first cellular phones 2 and 1, respectively.

(Step 4) The accounting apparatus 7 counts not only the rate for call due to establishment of a phone line between the first cellular phone terminal 1 and the second cellular phone terminal 2, but also separately a charging usage of the translating apparatus 6 as translation fee with respect to either of the first cellular phone terminal 1 and the second cellular phone terminal 2 by which the translation was requested.

In either of the first and second preferred embodiments, when the translating apparatus 6 is disposed in between the first cellular phone 1 and the second cellular phone 2 as occasion demands, it becomes possible to understand the contents spoken with the other persons, respectively, even if languages used by the other persons differ from one another.

In the first preferred embodiment, communication is possible with each other in the use of different languages from the beginning of the conversation. On the other hand, in the second preferred embodiment wherein a direct connection has been initially established by means of the phone line (3), and thereafter, when both the users feel inconvenience in its communication, the translating apparatus 6 is disposed later in between the phone line (1) and the phone line (2), whereby the communication between them becomes easy, even if they speak with different languages.

In the above-mentioned preferred embodiments, while the network 3 has been applied to a mobile telephone network, it is also applicable for either of fixed telephone network and Internet telephone network.

Moreover, since a system for embodying the invention is disposed on the ground, a translating apparatus can be scaled up, besides there is such another advantage that the translating apparatus can be placed anywhere at will. A possibility of scale-up in the apparatus means to obtain a translating apparatus by which high-speed processing can be performed, while optional selection for locating the apparatus results in the following advantages.

Namely, although a single translating apparatus 6 has been provided in the preferred embodiment of the present invention, translating apparatuses may be disposed in a plurality of places on a network in a dispersal manner, whereby it becomes possible to provide translation service by means of a translating apparatus that is placed at the nearest so a certain user in this case, a traffic for translation does not concentrate in a particular area, so that the service can be provided for much more users, besides it becomes an excellent system in view of service efficiency or delay time in phone line in use.

As described above, when translation service according to the present invention is applied to a mobile communication system such as cellular phone, and PHS (Personal Handy Phone system), there is such an advantage that communication becomes possible between users who speak different languages irrespective of places where these users exist at present. Particularly, when the translation system according to the present invention is applied to conversation with respect to a foreigner who stands before users eyes, good communication can be easily attained.

Furthermore, according to the present invention, translation is implemented by a translating apparatus or translating apparatuses connected to a network on a ground system, there is no limitation as to a size and a scale of the translating apparatus (or translating apparatuses), so that there is an advantage capable of providing service with respect to many users.

Moreover, according to the present invention, it is also possible to dispose translating apparatuses in a plurality of places on a network in a dispersal manner, so that there are such advantages that concentration of traffic for translation can be prevented to provide service with respect to many users as well as to provide an excellent system relating to service efficiency or delay time in phone line in use.

It will be appreciated by those of ordinary skill in the art that the present invention can be embodied in other specific forms without departing from the spirit or essential characteristics thereof.

The presently disclosed embodiments are therefore considered in all respects to be illustrative and not restrictive. The scope of the invention is indicated by the appended claims rather than the foregoing description and all changes that come within the meaning and range of equivalents thereof are intended to be embraced therein.

What is claimed is:

1. A method for providing translation service through a network, comprising the steps of:
(Step 1) delivering language information as to its own language as well as the other person's language, a telephone number of a first telephone terminal as well as a telephone number of a second telephone terminal belonging to said other person together with information for requesting translation from said first telephone terminal to a network at the time of establishing a phone line,
(Step 2) connecting said first telephone terminal with said second telephone terminal by means of said network through a translating apparatus, which has been previously prepared;
(Step 3) translating a speaking in said first telephone terminal and a speaking in said second telephone terminal by means of said translating apparatus in accordance with said language information to deliver both the spoken contents translated to their opposite parties' telephone terminals, respectively; and
(Step 4) counting a time required for the translation by means of an accounting apparatus which has been prepared previously on said network, to charge the fee as a translation fee, and adding the translation fee to a rate for a call caused by a phone call between said first telephone terminal and said second telephone terminal.

2. A method for providing translation service as claimed in claim 1, wherein:
said first telephone terminal and said second telephone terminal are cellular phones or Personal Handy Phones, respectively.

3. A method for providing translation service as claimed in claim 1, wherein:
said network is a fixed telephone network.

4. A method for providing translation service as claimed in claim 1, wherein:
said network is an internet telephone network.

5. A method for providing translation service through a network, comprising the steps of:
(Step 1) delivering language information as to languages spoken by a first telephone terminal and a second telephone terminal together with information for requesting translation from either of said first telephone terminal and said second telephone terminal to a net work in the case where a phone line for a phone call is in an established condition between said first telephone terminal and said second telephone terminal;
(Step 2) reconnecting said first telephone terminal with said second telephone terminal by means of said network through a translating apparatus, which has been previously prepared;
(Step 3) translating a speaking in said first telephone terminal and a speaking in said second telephone terminal by means of said translating apparatus in accordance with said language information to deliver both the spoken contents translated to their opposite parties' telephone terminals, respectively; and
(Step 4) counting not only a rate for a call produced by a phone call between said first telephone terminal and said second telephone terminal, but also separately a charging usage of said translating apparatus by means of an accounting apparatus, which has been prepared previously on said network with respect to said first telephone terminal or said second telephone terminal from either of which the translation was requested.

6. A method for providing translation service as claimed in claim 5, wherein:
said first telephone terminal and said second telephone terminal are cellular phones or Personal Handy Phones, respectively.

7. A method for providing translation service as claimed in claim 5, wherein:
said network is a fixed telephone network.

8. A method for providing translation service as claimed in claim 5, wherein:
said network is an internet telephone network.
